(19) United States
(12) Patent Application Publication
(10) Pub. No.: US 2003/0192015 A1
(43) Pub. Date: Oct. 9, 2003

(54) Method and apparatus to facilitate test pattern design for model calibration and proximity correction

(75) Inventor: Hua-yu Liu, Palo Alto, CA (US)

Correspondence Address: NUMERICAL C/O PARK, VAUGHAN & FLEMING LLP, SUITE 201, 508 SECOND STREET, DAVIS, CA, 95616-4692, US

(73) Assignee: Numerical Technologies, Inc., San Jose, CA

(21) Appl. No.: 10/116,286

(22) Filed: Apr. 4, 2002

(51) Int. Cl. G06F 17/50

(52) U.S. Cl. 716/4

(57) ABSTRACT

By using a test pattern that has been corrected according to an optical model to prepare test wafers, better data can be obtained for calibrating the optical model. As a result: fewer measurements need to be taken from the wafer to calibrate the model and the measurements that are taken are more valuable because they better assist in calibrating the model. Embodiments of the invention include data comprising the corrected test pattern, masks including the corrected test pattern, and methods and apparatuses for using the modified test pattern. Additionally, by taking more measurements closer to the target dimensions, more information is available for performing optical proximity correction of layouts. Another benefit includes increased ease of model accuracy determinations.

### BACKGROUND

1. Field of the Invention

The invention relates to the process of manufacturing an integrated circuit. More specifically, the invention relates to a method and an apparatus for calibrating a model related to manufacturing the integrated circuit.

2. Related Art

Integrated circuits can be produced through an optical lithography process that involves creating a mask with a pattern specifying where the various features of the integrated circuit are to be placed and then passing radiation through the mask to expose the pattern on a semiconductor wafer. This pattern defines where the surface of the semiconductor wafer is to be etched or where new material is to be added to create the integrated circuit.

As the features of an integrated circuit continue to get smaller, resist effects, diffraction and process effects, and other manufacturing process variations become more significant. These diffraction effects cause the actual width of a line to change from the designed width. The pitch of the lines also affects the diffraction and can change the actual line width from the desired width. FIG. 1A illustrates line width and pitch. Line width 102 is the width of a line, while pitch 104 is the pitch of the lines. Note that pitch 104 includes line width 102 and the space between lines. Optionally, pitch can be measured from midpoint of a line to the midpoint of the next line.

Process engineers create a wafer using a test pattern in order to calibrate a computer model of the process. Process engineers then use the computer model to apply corrections to the layout design so that the finished wafer has the desired dimensions after the process is complete. FIG. 1B is a flowchart illustrating the process of creating model corrections. The system starts when a test pattern containing multiple line widths and pitches is received (step 106). Next, the system creates a mask from the test pattern (step 108). A test wafer is then formed using the mask (step 110).

After the test wafer has been fabricated, the actual line widths and pitches are measured (step 112). Next, the actual line widths are compared with the desired line widths to determine the error in the actual line widths (step 114). Finally, the measured error is used to calibrate the model so that the model will more accurately approximate actual line widths (step 116).

Except in some special cases, this method is not satisfactory because the measured errors are not linear. This non-linearity causes the model corrections to be understated or overstated, thereby requiring additional test wafers to be created. In the worse case, the corrections never converge on the desired line width. FIG. 1C is a graph plotting actual line width versus pitch for a target line width of 160 nm. Target CD 118 indicates the target line width of 160 nm. The region labeled valuable data 120 provides more useful information for the model. However, the regions labeled less valuable data 122 are far removed from target CD 118 and are in non-linear regions so that model corrections are difficult to compute.

What is needed is a method and an apparatus to facilitate test pattern design for model calibration and proximity correction that do not exhibit the problems described above.

### SUMMARY

One embodiment of the invention provides a system for using a test pattern to calibrate a model of a manufacturing process for an integrated circuit. The system operates by first receiving a basic test pattern and then performing optical proximity correction (OPC) on this basic test pattern using an optical model. This optical proximity correction creates a partially corrected or modified test pattern. This partially corrected test pattern is optical proximity effect free. A mask is generated from the partially corrected test pattern and then a test wafer is created using the mask. The system measures features on the test wafer to determine a difference between the desired width and the width on the test wafer. The system calibrates the model using this difference.

In one embodiment of the invention, the basic test pattern includes multiple line widths and for each line width the basic test pattern includes multiple line pitches.

In one embodiment of the invention, performing optical proximity correction on the basic test pattern compensates for optical effects involved in creating the test wafer.

In one embodiment of the invention, the difference between the partially corrected test pattern and the test wafer includes multiple measurements for each line width and pitch.

In one embodiment of the invention, the system sorts the measurements according to the expected line width.

In one embodiment of the invention, the system compares the expected line width at a specified pitch with the actual line width at the specified pitch to determine the model error, thereby creating measurements closer to the target dimension and providing more information for accurate OPC.

In one embodiment of the invention, the system calibrates the model to compensate for the model error allowing easier judgment about the model accuracy by a process engineer.

In one embodiment of the invention, receiving the test pattern includes designing the test pattern with a plurality of lines having different widths and pitches arranged in a grid.

### BRIEF DESCRIPTION OF THE FIGURES

FIG. 1A illustrates line width and pitch.

FIG. 1B is a flowchart illustrating the process of calibrating a model.

FIG. 1C is a graph plotting actual line width versus pitch for a target line width.

FIG. 2A is a flowchart illustrating the process of calibrating an optical model in accordance with an embodiment of the invention.

FIG. 2B is a graph plotting actual line width versus pitch for a target line width in accordance with an embodiment of the invention.

FIG. 3 illustrates model calibration in accordance with an embodiment of the invention.

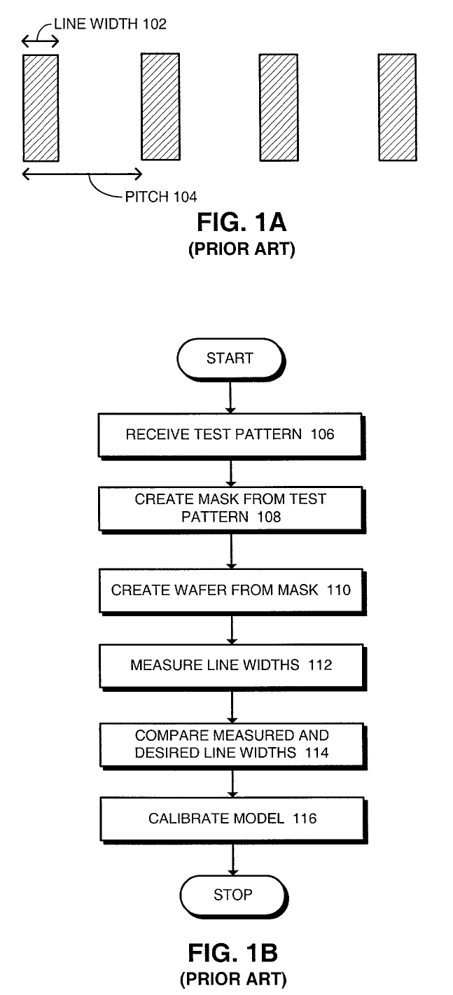

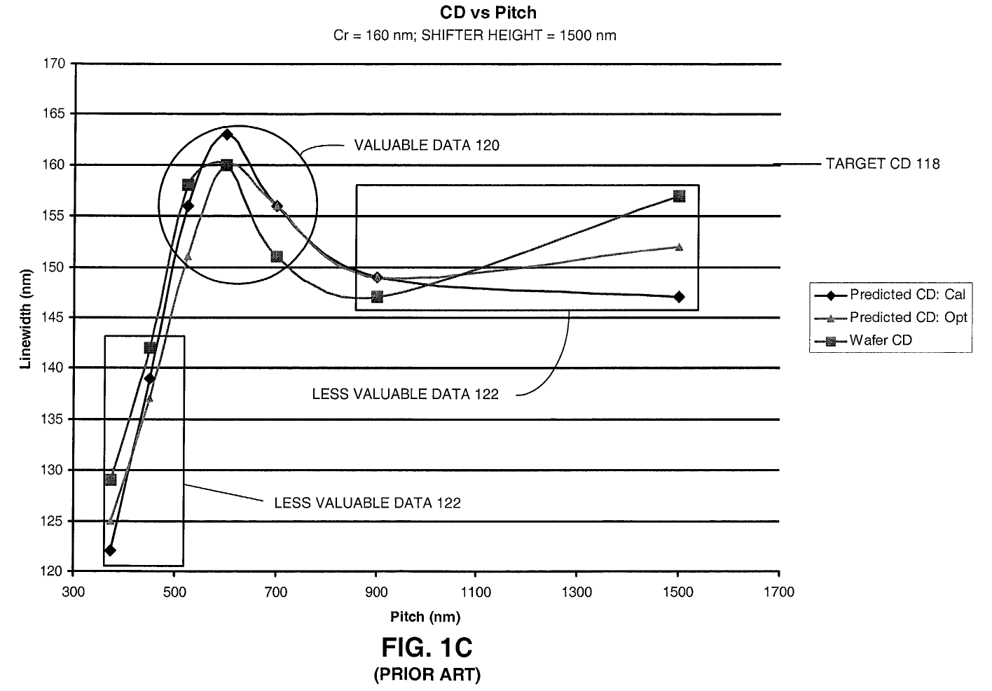

### DETAILED DESCRIPTION

Creating Model Calibrations

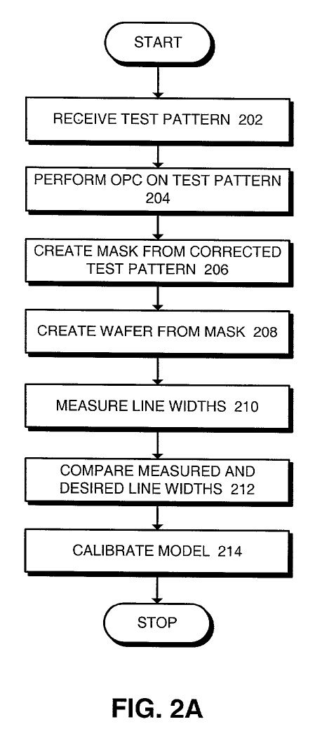

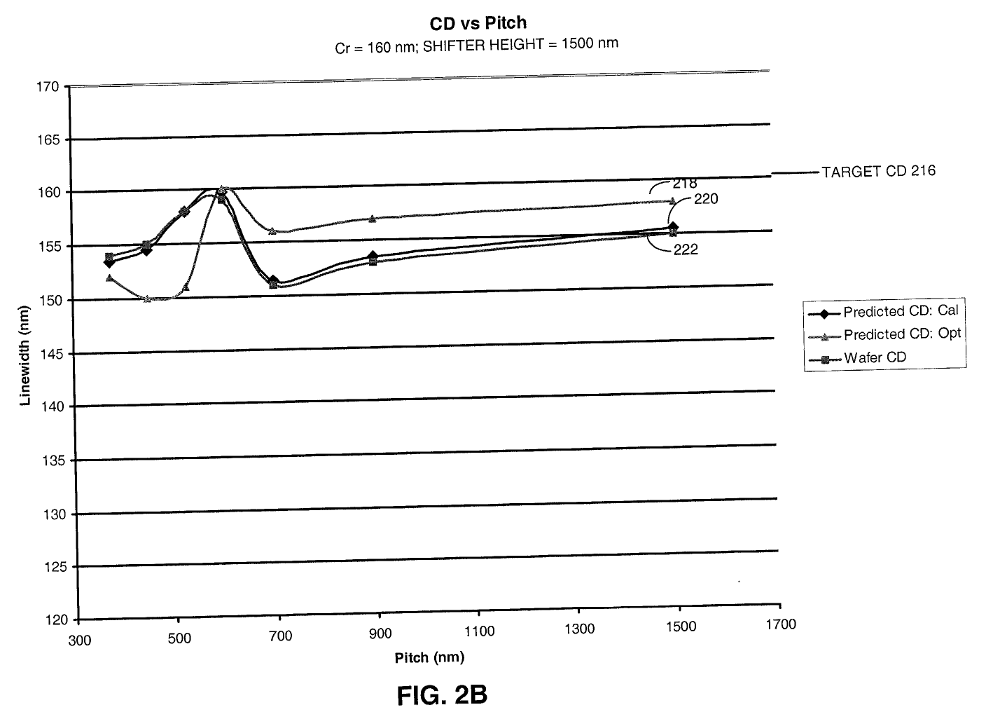

FIG. 2A is a flowchart illustrating the process of calibrating an optical model in accordance with an embodiment of the invention. An optical model is a model created by a model generator such as ModelGen™, which corrects for optical effects while creating an integrated circuit. These effects include numerical aperture (NA), wavelength (λ), and sigma (σ). Calibrating this model with a model calibrator such as ModelCal™ allows the calibrated model to compensate for resist and/or etch effects. ModelGen™ and ModelCal™ are trademarks or registered trademarks of Numerical Technologies, Inc. of San Jose, Calif. The system starts when a basic test pattern containing multiple line widths and pitches is received (step 202). Next, the system performs optical proximity correction on the test pattern (step 204). Note that performing optical proximity correction on the test pattern at this stage provides more accurate results on the wafer line widths and, therefore, provides better data for model calibration. A mask is then created from the test pattern (step 206). After creating the mask, a test wafer is formed using the mask (step 208).

After the test wafer has been fabricated, the actual line widths and pitches are measured (step 210). Next, the actual line widths are compared with the desired line widths to determine the error in the actual line widths (step 212). Finally, the model is calibrated for resist and/or etch effects so that the model will create line widths closer to the desired line widths (step 214). Since optical proximity correction has been performed on the test pattern, the corrections are more accurate and determined with fewer measurements and calculations.

FIG. 2B is a graph plotting actual line width versus pitch for a target line width in accordance with an embodiment of the invention. Curve 218 illustrates the predicted critical dimension (CD) from the optical model. Curve 220 illustrates the predicted CD from the calibrated model. Curve 222 illustrates the measured CD on a wafer. As illustrated, the differences from these curves to target CD 216 are relatively small and are more linear.

Model Calibration

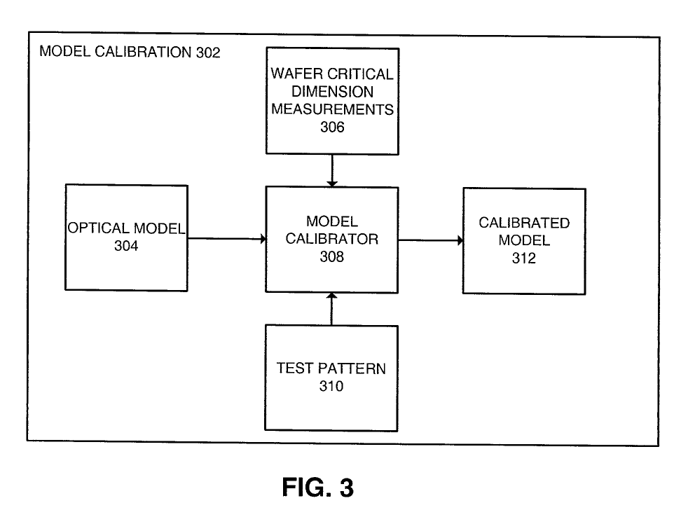

FIG. 3 illustrates model calibration 302 in accordance with an embodiment of the invention. The system starts with optical model 304, test pattern 310, and wafer critical dimension measurements 306. Optical model 304 applies corrections to mask patterns in a format such as GDSII stream format. Test pattern 310 is a pattern of multiple line widths at multiple pitches after optical proximity correction as described above. Wafer critical dimension measurements 306 are measurements of the lines on a test wafer corresponding to the lines on test pattern 310. These wafer critical dimension measurements 306 include resist and/or etch effects.

Model calibrator 308 receives optical model 304, test pattern 310, and wafer critical dimension measurements 306. Model calibrator 308 then determines corrections to be made to optical model 304 by comparing wafer critical dimension measurements 306 with test pattern 310 to determine the magnitude and direction of the errors. Finally, model calibrator 308 calibrates optical model 304 using the calculated measurements to generate a calibrated model 312. The ModelCal™ software from Numerical Technologies, Inc. can be used.

The preceding description is presented to enable one to make and use the invention, and is provided in the context of a particular application and its requirements. Various modifications to the disclosed embodiments will be readily apparent, and the general principles defined herein may be applied to other embodiments and applications without departing from the spirit and scope of the invention. The invention can be readily adapted to be used with “next generation” optical lithography techniques including, but not limited to, deep ultraviolet (DUV), extreme ultraviolet (EUV), x-ray, and e-beam with suitable adaptations. Thus, the invention is not intended to be limited to the embodiments shown, but is to be accorded the widest scope consistent with the principles and features disclosed herein.

The data structures and code described in this detailed description can be stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet. In one embodiment of the invention, the computer instruction signals can include instructions for calibrating a model from CD measurements taken from a test wafer.

The foregoing descriptions of embodiments of the invention have been presented for purposes of illustration and description only. They are not intended to be exhaustive or to limit the invention to the forms disclosed. The scope of the invention is defined by the appended claims.

What is claimed is:

1. A method for using a test pattern to calibrate an optical model related to a manufacturing process for an integrated circuit, comprising:
receiving the test pattern;
performing optical proximity correction on the test pattern using the optical model, thereby creating a partially corrected test pattern;
generating a test mask from the partially corrected test pattern;
fabricating a wafer using the test mask;
measuring features on the wafer to generate a plurality of measurements; and
calibrating the optical model using the plurality of measurements.

2. The method of claim 1, wherein the test pattern includes a plurality of line widths, wherein for each line width the test pattern includes a plurality of line pitches.

3. The method of claim 1, wherein performing optical proximity correction on the test pattern compensates for optical effects involved in the manufacturing process.

4. The method of claim 1, further comprising determining a difference between the partially corrected test pattern and the plurality of measurements for each line width and pitch.

5. The method of claim 4, further comprising comparing an expected line width at a specified pitch with an actual line width at the specified pitch to determine a model error.

6. The method of claim 5, further comprising calibrating the optical model to compensate for resist and etch effects.

7. The method of claim 1, wherein receiving the test pattern includes designing the test pattern with a plurality of lines having different widths and pitches arranged in a grid.

8. A computer-readable storage medium storing instructions that when executed by a computer cause the computer to perform a method for using a test pattern to calibrate an optical model related to a manufacturing process for an integrated circuit, the method comprising:
receiving the test pattern;
performing optical proximity correction on the test pattern using the optical model, thereby creating a partially corrected test pattern;
generating a test mask from the partially corrected test pattern;
fabricating a wafer using the test mask;
measuring features on the wafer to generate a plurality of measurements; and
calibrating the optical model using the plurality of measurements.

9. The computer-readable storage medium of claim 8, wherein the test pattern includes a plurality of line widths, wherein for each line width the test pattern includes a plurality of line pitches.

10. The computer-readable storage medium of claim 8, wherein performing optical proximity correction on the test pattern compensates for optical effects involved in the manufacturing process.

11. The computer-readable storage medium of claim 8, the method further comprising determining a difference between the partially corrected test pattern and the plurality of measurements for each line width and pitch.

12. The computer-readable storage medium of claim 11, the method further comprising comparing an expected line width at a specified pitch with an actual line width at the specified pitch to determine a model error.

13. The computer-readable storage medium of claim 12, the method further comprising calibrating the optical model to compensate for resist and etch effects.

14. The computer-readable storage medium of claim 8, wherein receiving the test pattern includes designing the test pattern with a plurality of lines having different widths and pitches arranged in a grid.

15. An apparatus, for using a test pattern to calibrate an optical model related to a manufacturing process for an integrated circuit, comprising:
a receiving mechanism that is configured to receive the test pattern;
an optical proximity correction mechanism that is configured to perform optical proximity correction on the test pattern using the optical model, thereby creating a partially corrected test pattern;
a generating mechanism that is configured to generate a test mask from the partially corrected test pattern;
a fabricating mechanism that is configured to fabricate a wafer using the test mask;
a measuring mechanism that is configured to measure features on the wafer to generate a plurality of measurements; and
a calibrating mechanism that is configured to calibrate the optical model using the plurality of measurements.

16. The apparatus of claim 15, wherein the test pattern includes a plurality of line widths, wherein for each line width the test pattern includes a plurality of line pitches.

17. The apparatus of claim 15, wherein performing optical proximity correction on the test pattern compensates for optical effects involved in the manufacturing process.

18. The apparatus of claim 15, further comprising a difference determining mechanism that is configured to determine a difference between the partially corrected test pattern and the plurality of measurements for each line width and pitch.

19. The apparatus of claim 18, further comprising a comparing mechanism that is configured to compare an expected line width at a specified pitch with an actual line width at the specified pitch to determine a model error.

20. The apparatus of claim 19, wherein the calibrating mechanism is further configured to calibrate the optical model to compensate for resist and etch effects.

21. The apparatus of claim 15, further comprising a designing mechanism that is configured to design the test pattern with a plurality of lines having different widths and pitches arranged in a grid.

22. A system for using a test pattern to calibrate an optical model related to a manufacturing process for an integrated circuit, comprising:
receiving the test pattern;
performing optical proximity correction on the test pattern using the optical model, thereby creating a partially corrected test pattern;
generating a test mask from the partially corrected test pattern;
fabricating a wafer using the test mask;
measuring features on the wafer to generate a plurality of measurements; and
calibrating the optical model using the plurality of measurements.

23. An optical proximity corrected test mask used for calibrating an optical model, comprising a plurality of lines within the optical proximity corrected test mask, wherein the plurality of lines have been partially corrected by an optical proximity correction process to compensate for optical effects.

24. The optical proximity corrected test mask of claim 23, wherein the plurality of lines includes a plurality of line widths.

25. The optical proximity corrected test mask of claim 24, wherein the plurality of lines includes a plurality of line pitches for each of the plurality of line widths.

26. A data set related to an optical proximity corrected test pattern used for calibrating an optical model, comprising:
a plurality of specified line widths;
a plurality of pitches for each of the plurality of specified line widths; and
a plurality of measured line widths, wherein the plurality of measured line widths are measured on a wafer fabricated using the optical proximity corrected test pattern.

27. The data set of claim 26, further comprising a plurality of differences computed by comparing a measured line width of the plurality of measured line widths with a specified line width in the plurality of specified line widths for each line.

28. The data set of claim 27, wherein the plurality of differences is used to calibrate the optical model.

29. An electromagnetic waveform encoding instructions that when executed by a computer cause the computer to perform a method for using a test pattern to calibrate an optical model related to a manufacturing process for an integrated circuit, the method comprising:
receiving the test pattern;
performing optical proximity correction on the test pattern using the optical model, thereby creating a partially corrected test pattern;
generating a test mask from the partially corrected test pattern;
fabricating a wafer using the test mask;
measuring features on the wafer to generate a plurality of measurements; and
calibrating the optical model using the plurality of measurements.
